(19) United States
(12) Patent Application Publication
(10) Pub. No.: US 2002/0120678 A1
(43) Pub. Date: Aug. 29, 2002

(54) Locally distributed databases

(75) Inventors: Jeffrey Allen Jones, Round Rock, TX (US); Douglas Scott Rothert, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/796,043

(22) Filed: Feb. 28, 2001

(51) Int. Cl. G06F 15/16

(52) U.S. Cl. 709/203

(57) ABSTRACT

A client local storage is provided that exists on a client machine but is accessible by a server. The client local storage allows the server to “push” the actual storage of data files to the client machine. Users may then contribute local storage toward maintaining useful, but non-critical files without burdening the server for storage and backup facilities. Thus, the server may decide to push data, such as large attachments, to client local storage. Client local storage may also be used for archival of older versions of files.

### BACKGROUND OF THE INVENTION

1. Technical Field

The present invention relates to network data processing systems and, in particular, to shared databases. More particularly, the present invention relates to locally distributed databases on client machines to be used by servers for storage of shared databases.

2. Description of Related Art

Notes™ is a messaging and groupware software application from Lotus. Notes provides e-mail, document sharing, workflow, group discussions and calendaring and scheduling. The heart of Notes, and what makes it different from other groupware, is its document database. Everything, including e-mail and group discussions, are maintained in a Notes database, which can hold data fields, text, audio and video.

Notes provides strong replication capability, which synchronizes databases distributed in multiple locations and to mobile users. Large, shared databases and servers that depend on them, such as e-mail and Notes servers, often have finite constraints on the storage available to them, particularly with respect to the volume of data to be backed up. However, there is often a desire on the part of users to keep more data than the server allows.

Therefore, it would be advantageous to provide locally distributed databases to be used by servers for database storage.

### SUMMARY OF THE INVENTION

The present invention provides client local storage that exists on a client machine but is accessible by a server. The client local storage allows the server to “push” the actual storage of data files to the client machine. Users may then contribute local storage toward maintaining useful files without burdening the server for storage and backup facilities. Thus, the server may decide to push data, such as large attachments, to client local storage. Client local storage may also be used for archival of older versions of files.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIGS. 4A and 4B are block diagrams illustrating a client/server environment in accordance with a preferred embodiment of the present invention;

FIG. 5 is a block diagram illustrating the components of a database server and a client in accordance with a preferred embodiment of the present invention;

FIG. 6 is a diagram illustrating data to be stored in a database in accordance with a preferred embodiment of the present invention; and

FIG. 7 is a flowchart illustrating the operation of a server in communication with a client in accordance with a preferred embodiment of the present invention.

### DETAILED DESCRIPTION OF THE PREFERRED EMBODIMENT

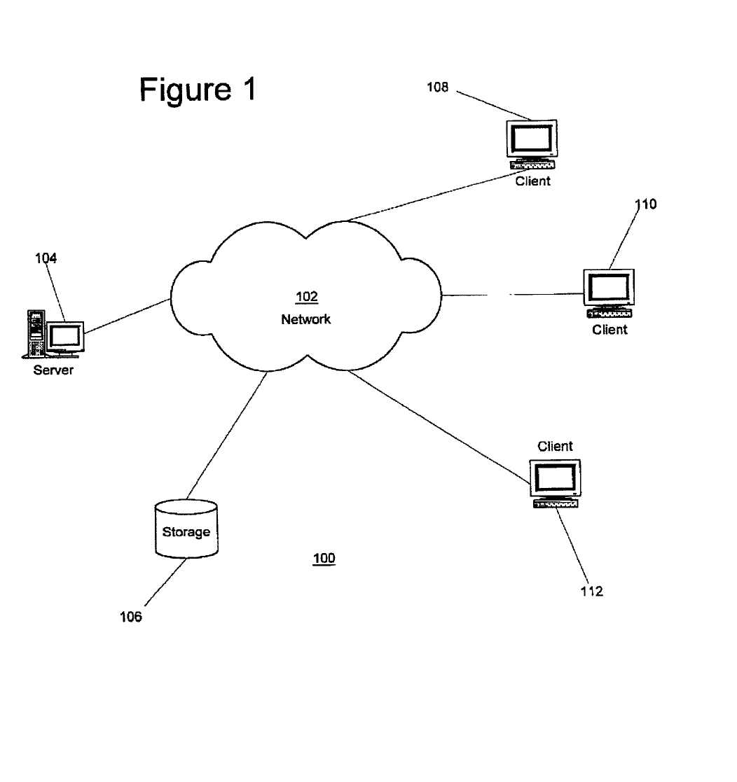

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

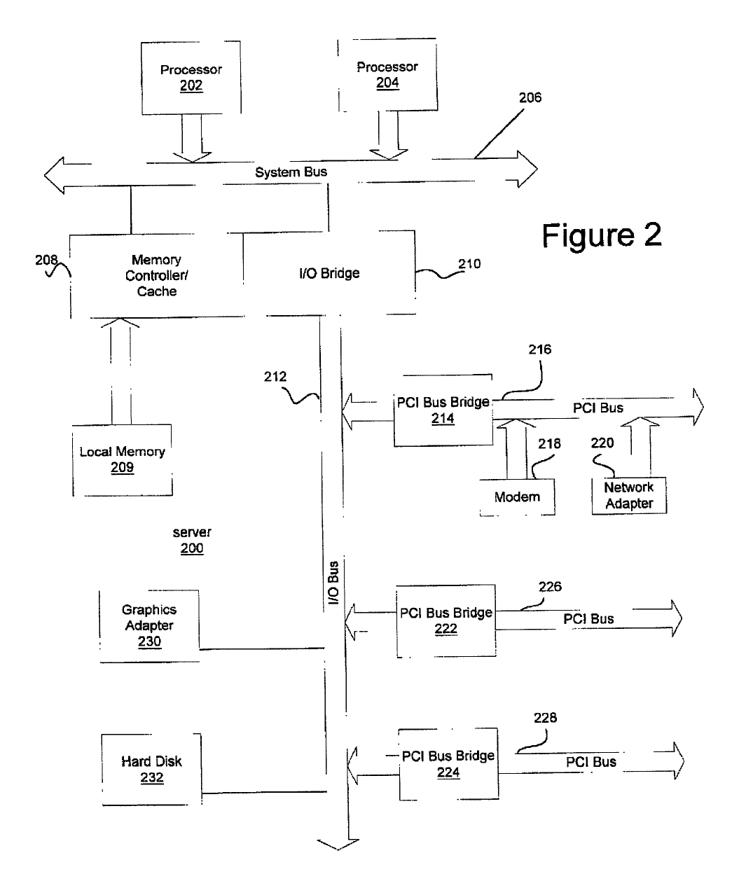

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

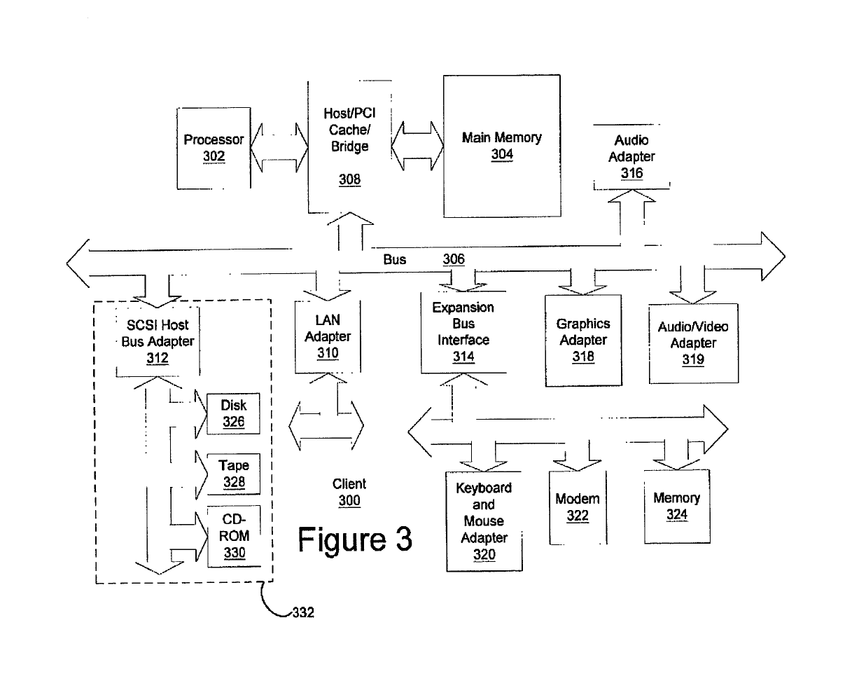

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

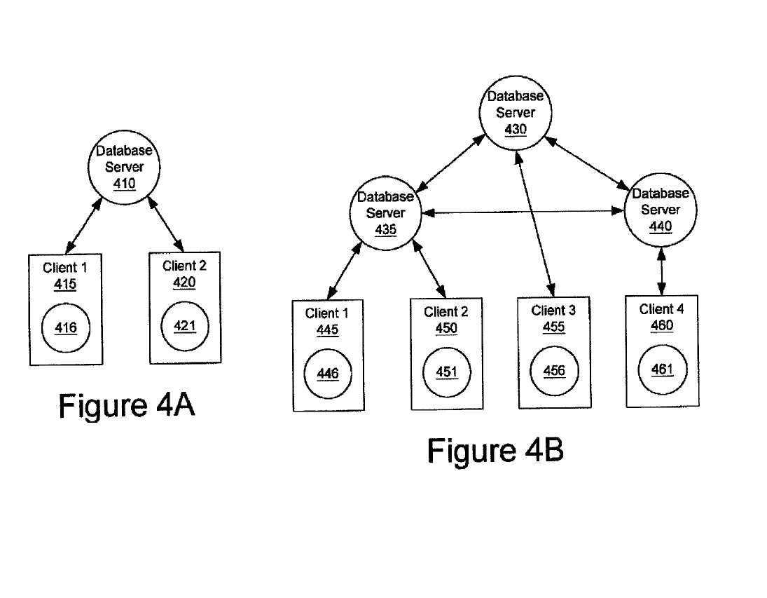

With reference now to FIGS. 4A and 4B, block diagrams are shown illustrating a client/server environment in accordance with a preferred embodiment of the present invention. Particularly, with respect to FIG. 4A, database server 410 provides data to client 1 415 and client 2 420. Client 1 and client 2 share a common database through a common server 410, such as an e-mail server or Notes server. Client 1 provides client local storage 416 and client 2 provides client local storage 421. The server then may push data to client local storage 416 or client local storage 421 or both.

For example, client 1 may send an e-mail message to client 2 with a large attachment, such as a compact disk (CD) image. The server will store the message and attachment in the “sent mail” storage of client 1 and the “inbox” storage of client 2. Each client replicates its respective portion of the database. The server may decide, on a client-by-client basis, whether to push the attachment to client local storage. This decision may be made based on several factors, such as the size of the file, the volume of storage used by each client, and the amount of client local storage available on each client. Thus, the client may push the instance of the attachment in the “sent mail” storage of client 1 to the client local storage of client 1 and the instance of the attachment in the “inbox” storage of client 2 to the client local storage of client 2. However, if the user of client 2 is a heavy user of the database and the user of client 1 is a casual user of the database, the server may decide to push the attachment to the client local storage of client 2 and not to the client local storage of client 1.

Alternatively, the server may keep one copy of the attachment in the client local storage of client 1. When client 2 attempts to access the attachment, the server retrieves the file from the client local storage of client 1. Client 1 must be left online to ensure that the client local storage is available to the server. This is transparent to client 2.

Turning now to FIG. 4B, database servers 430, 435, 440 provide data to client 1 445, client 2 450, client 3 455, and client 4 460. Client 1 provides client local storage 446, client 2 provides client local storage 451, client 3 provides client local storage 456, and client 4 provides client local storage 461. The servers may be mirrored servers or cooperating database servers, such as Notes servers or other e-mail servers.

For example, client 1 445 may send an e-mail message with a large attachment to client 4 460. Database server 435 may decide whether to push the attachment to the client local storage on client 1 while database server 440 may decide whether to push the attachment to client local storage on client 4. Alternatively, server 435 may push one instance of the attachment to client local storage 446 for use by all database servers.

A user may also contribute storage for use by other clients. For example, the user of client 2 450 may contribute client local storage 451 for use by client 1 445, client 3 455, and client 4 460. Access by client 1 of client local storage 451 to fulfill a transaction is transparent to client 1. A client may have client local storage belonging to and accessed by many servers. For example, client local storage 456 in client 3 455 may include storage belonging to database server 435 and database server 440.

Furthermore, many clients may contribute client local storage to a server. This storage may be used only on the behalf of the client on which the storage resides. Alternatively, the storage may be for general aggregate use. For example, a single client machine may contribute client local storage for an entire department. The storage may also be some combination of client-specific use and general aggregate use, negotiated between the client and the server. Client local storage may also be used for archival of older versions of files.

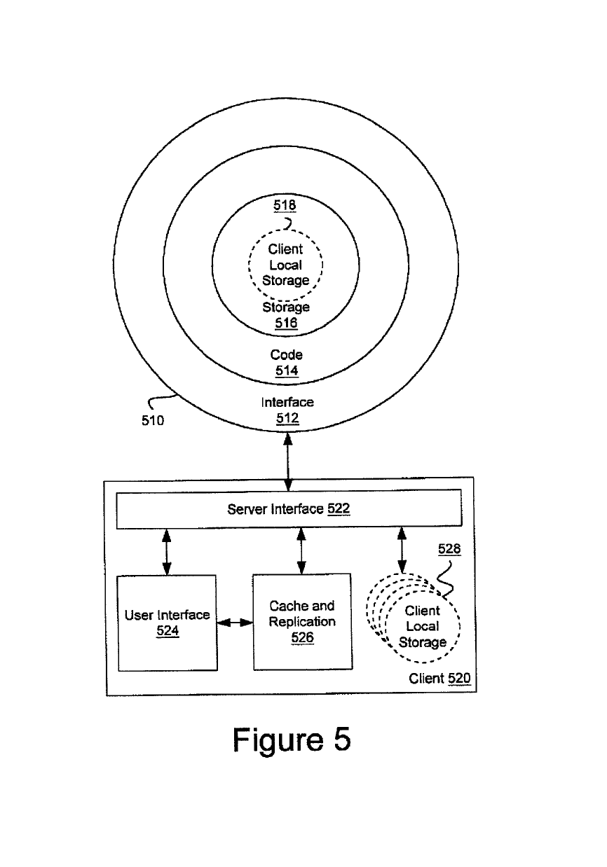

With reference now to FIG. 5, a block diagram illustrating the components of a database server and a client is shown in accordance with a preferred embodiment of the present invention. Server 510 provides data to client 520. The server includes interface 512, management code 514, and storage 516. Interface 512 communicates with server interface 522 of client 520. The interface, code, and storage may be in the same process or different processes or on the same or different machines. The “server” may actually be many servers via mirrors and/or replication.

In addition to server interface 522, client 520 includes user interface 524, cache and replication 526, and client local storage 528. Client local storage 528 may include storage for a plurality of different servers or for use by a plurality of different clients.

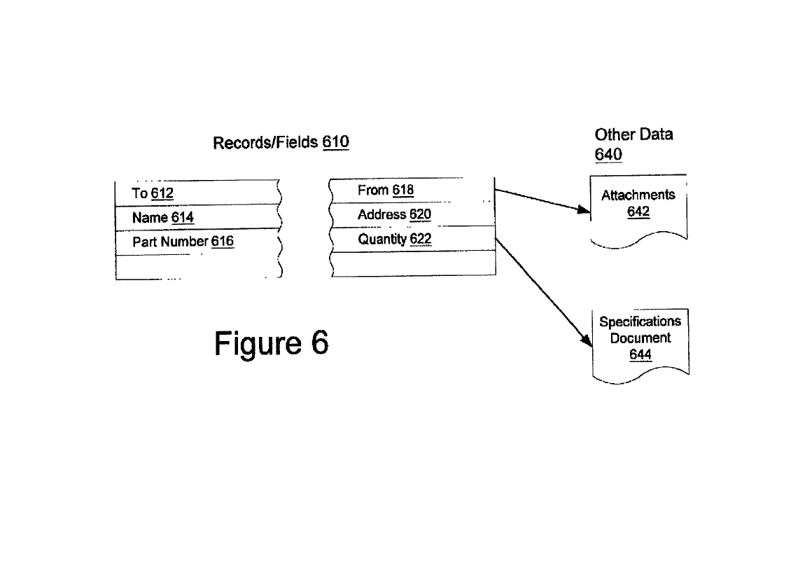

With reference to FIG. 6, a diagram is shown illustrating data to be stored in a database in accordance with a preferred embodiment of the present invention. A database record, such as electronic data interchange (EDI) message, may include records/fields 610 and other data 620. Records/fields may include a “To” field 612, “Name” field 614, “Part Number” field 616, “From” field 618, “Address” field 620, and a “Quantity” field 622. The record may also include an attachment 642 and a specifications document 644.

A server may decide to push parts of all of the other data to a client local storage. For example, a server may decide to push attachment 642, specifications document 644, or both to a client local storage. This decision may be made based on factors such as the size of the attachment and the specifications document, the amount of volume usage by the client, and the amount of available client data storage.

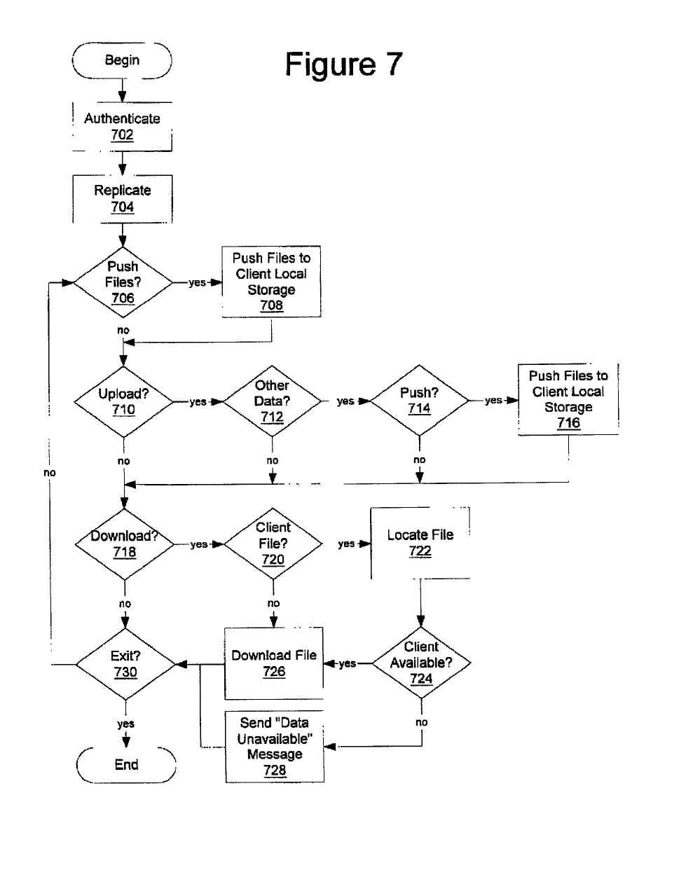

Turning now to FIG. 7, a flowchart is shown illustrating the operation of a server in communication with a client in accordance with a preferred embodiment of the present invention. The process begins and authenticates the client (step 702). The server then allows the client to replicate (step 704) and a determination is made as to whether files exist to be pushed to the client (step 706). If files to be pushed exist, the process pushes the files to the client local storage (step 708) and a determination is made as to whether a request to upload data, such as a sent e-mail message, is received (step 710).

If files to be pushed do not exist in step 706, the process proceeds directly to step 710 to determine whether a request to upload data is received. If a request to upload data is received, a determination is made as to whether other data exists in the uploaded data (step 712). If other data exists, a determination is made as to whether to push the other data to client local storage (step 714). If all or a portion of the other data is to be pushed, the process pushes the files to client local storage (step 716) and a determination is made as to whether a request to download data is received.

If other data is not to be pushed to client local storage in step 714, other data does not exist in uploaded data in step 712, or a request to upload data is not received in step 710, then the process proceeds to step 718 to determine whether a request to download data is received. If a request to download data is received, a determination is made as to whether the data is stored as part of the database in client local storage (step 720). If the requested file is in client local storage, the process locates the file (step 722) and a determination is made as to whether the client on which the file is located is available (step 724).

If the client is available, the process downloads the file (step 726) and a determination is made as to whether an exit condition exists (step 730). If the client is not available in step 724, the process sends a “Data Unavailable” message to the requesting client (step 728) and a determination is made as to whether an exit condition exists (step 730). If the requested file is not in client local storage in step 720, the process downloads the file to the client (step 726) and a determination is made as to whether an exit condition exists (step 730).

Returning to step 718, if a download request is not received, the process proceeds to step 730 to determine whether an exit condition exists. An exit condition may exist, for example, when the client disconnects from the server or when the server shuts down. If an exit condition does not exist, the process returns to step 706 to determine whether files to be pushed to client local storage exist in the database. If an exit condition does not exist in step 730, the process ends.

Thus, the present invention solves the disadvantages of the prior art by providing client-side storage for use by a server. The present invention allows users to contribute storage toward maintaining useful, but non-critical data without burdening the server storage or back-up facilities. Alternatively, the client local storage may store critical data if the client is continuously available. This critical data may be backed up more frequently at the discretion of the user of the client. Because the contributed client local storage is owned and controlled by the server, the server may operate within storage constraints and maintain file integrity.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a database server, for managing client local storage, comprising:
identifying a database file to be stored in storage on a first client device;
pushing the database file to a client local storage on the first client device;
receiving a request for the database file from a second client device; and
transferring the database file from the client local storage to the second client device.

2. The method of claim 1, wherein the database file is one of an e-mail attachment and a specifications document.

3. The method of claim 1, wherein the step of transferring the database file comprises locating the database file in the client local storage.

4. The method of claim 3, wherein the step of transferring the database file further comprises:
retrieving the database file from the client local storage; and
sending the database file to the second client device.

5. A method, in a database server, for managing client local storage, comprising:
receiving a message including an attachment file from a first client device;
determining whether the attachment file is to be stored locally; and
pushing the attachment file to a client local storage in response to a determination that the attachment file is to be stored locally.

6. The method of claim 5, wherein the step of determining whether the attachment file is to be stored locally comprises determining whether the size of the attachment file exceeds a threshold.

7. The method of claim 5, wherein the step of determining whether the attachment file is to be stored locally comprises determining whether database storage used by the first client device exceeds a threshold.

8. The method of claim 5, wherein the client local storage resides on the first client device.

9. The method of claim 5, further comprising:
receiving a request for the attachment file from a second client device;
locating the attachment file in the client local storage; and
transferring the database file from the client local storage to the second client device.

10. A method, in a first client device, for managing client local storage, comprising:
providing a client local storage to be used and controlled by a database server to store files;
sending a database file to the server for storage;
receiving the database file from the server, upon a determination that the database file is to be stored in the client local storage; and
storing the database file in the client local storage.

11. The method of claim 10, wherein the database file is one of an e-mail attachment and a specifications document.

12. The method of claim 10, further comprising:
receiving a request for the database file from the server; and
sending the database file to the server.

13. An apparatus, in a database server, for managing client local storage, comprising:
identification means for identifying a database file to be stored in storage on a first client device;
push means for pushing the database file to a client local storage on the first client device;
receipt means for receiving a request for the database file from a second client device; and
transfer means for transferring the database file from the client local storage to the second client device.

14. The apparatus of claim 13, wherein the database file is one of an e-mail attachment and a specifications document.

15. The apparatus of claim 13, wherein the transfer means comprises means for locating the database file in the client local storage.

16. The apparatus of claim 15, wherein the transfer means further comprises:
means for retrieving the database file from the client local storage; and
means for sending the database file to the second client device.

17. A database server comprising:
a database storage; and
an interface,
wherein the interface receives a message including an attachment file from a first client device, determines whether the attachment file is to be stored locally, stores the message in the database storage, and pushes the attachment file to a client local storage in response to a determination that the attachment file is to be stored locally.

18. The server of claim 17, wherein the interface determines whether the size of the attachment file exceeds a threshold.

19. The server of claim 17, wherein the server determines whether database storage used by the first client device exceeds a threshold.

20. The server of claim 17, wherein the client local storage resides on the first client device.

21. The server of claim 17, wherein the interface receives a request for the attachment file from a second client device, locates the attachment file in the client local storage, and transfers the database file from the client local storage to the second client device.

22. A client device comprising:
a client local storage to be used and controlled by a database server to store files; and
an interface that sends a database file to the server for storage, receives the database file from the server upon a determination that the database file is to be stored in the client local storage, and stores the database file in the client local storage.

23. The client of claim 22, wherein the database file is one of an e-mail attachment and a specifications document.

24. The client of claim 22, wherein the interface receives a request for the database file from the server, and sends the database file to the server.

25. A computer program product, in a computer readable medium in a server, for managing client local storage, comprising:
instruction means for identifying a database file to be stored in storage on a first client device;
instruction means for pushing the database file to a client local storage on the first client device;
instruction means for receiving a request for the database file from a second client device; and
instruction means for transferring the database file from the client local storage to the second client device.

26. A computer program product, in a computer readable medium in a server, for managing client local storage, comprising:
instructions for receiving a message including an attachment file from a first client device;
instructions for determining whether the attachment file is to be stored locally; and
instructions for pushing the attachment file to a client local storage in response to a determination that the attachment file is to be stored locally.

27. A computer program product, in a computer readable medium in a client device, for managing client local storage, comprising:
instructions for providing a client local storage to be used and controlled by a database server to store files;
instructions for sending a database file to the server for storage;
instructions for receiving the database file from the server, upon a determination that the database file is to be stored in the client local storage; and
instructions for storing the database file in the client local storage.
